(19) United States
(12) Patent Application Publication
(10) Pub. No.: US 2018/0152215 A1
(43) Pub. Date: May 31, 2018

(54) ADJUSTABLE MOBILE DEVICE MOUNT AND METHOD THEREOF

(71) Applicant: George A. Simpson, III, Washington, DC (US)

(72) Inventor: George A. Simpson, III, Washington, DC (US)

(21) Appl. No.: 15/824,541

(22) Filed: Nov. 28, 2017

Related U.S. Application Data
(60) Provisional application No. 62/427,021, filed on Nov. 28, 2016.

(51) Int. Cl. H04B 1/3827

(52) U.S. Cl. CPC H04B 1/385; H04M 1/0202; H04B 2001/3861

(57) ABSTRACT

An adjustable mobile device mount including an attachment member having a first side and an opposing second side, the attachment member configured to detachably couple to a user, a device mounting member configured to detachably support a mobile device having a first surface and an opposing second surface, and an adjustable coupling member disposed between the attachment member and the device mounting member configured to rotate the mobile device along a first axis and a second axis orthogonal to the first axis.

This application claims the benefit of U.S. Provisional Application Ser. No. 62/427,021, filed Nov. 28, 2016. The disclosure of the prior application is incorporated herein in its entirety by reference.

### FIELD OF INVENTION

The present general inventive concept generally relates to mobile device accessories, and more particularly, to adjustable position mobile device mounts that are attachable to a user's hand.

### DESCRIPTION OF THE RELATED ART

Over the past several years, mobile device technology has improved so significantly that users are now able to capture high quality images and videos from almost every mobile device. However, in order to be constantly ready to capture images and videos, users are required to physically hold their mobile devices steady in their hands, risking damage to the mobile device due to accidental drops and damage to their wrists.

Further, users need to properly orient and stabilize their mobile devices in order to capture the images and videos in a desired orientation. However, manually orienting and holding mobile devices stable in a desired orientation for even a short period of time, causes a considerable amount of stress and fatigue on users hands and wrists.

Therefore, what is desired is a wearable mobile device mount which allows a user to quickly unfold a mobile device from a safe storage position and also to be able adjust and maintain a desirable orientation of the mobile device to capture images and videos and to reduce stress and fatigue of the user's hands and wrists.

### BRIEF SUMMARY OF THE INVENTION

The present general inventive concept generally relates to mobile device accessories, and more particularly, to adjustable position mobile device mounts that are attachable to a user's hand.

The present general inventive concept also generally relates to adjustable position mobile device mounts which are configured to support a mobile device in a plurality of positions and orientations.

The present general inventive concept also generally relates to adjustable position mobile device mounts which are configured to fold between a first position wherein a supported mobile device is safely secured in a storage position within a user's hand and a second position wherein the supported mobile device may be positioned for use.

Features and/or utilities of the present general inventive concept provide an adjustable mobile device mount which includes an attachment member having a first side and an opposing second side, the attachment member configured to detachably couple to a user, a device mounting member configured to detachably support a mobile device having a first surface and an opposing second surface, and an adjustable coupling member disposed between the attachment member and the device mounting member configured to rotate the mobile device along a first axis and a second axis orthogonal to the first axis.

The adjustable coupling member may be configured to allow the mobile device to fold between a first position for use and a second position for storage.

The adjustable coupling member may further be configured to allow the mobile device to rotate between a first orientation and a second orientation.

The first surface of the mobile device and the first side of the attachment member may face a same first direction in the first orientation and the first surface of the mobile device and the second side of the attachment member may face a same second direction in the second orientation.

The adjustable coupling member may further include a self-stabilizing member which stabilizes the first surface of the mobile device with respect to a ground surface.

The self-stabilizing member may keep the first surface of the mobile device perpendicular with respect to the ground surface.

The attachment member may be configured to detachably couple to the user's hand.

The first side of the attachment member may contact the user's hand.

The attachment member may further include an elastic strap member to detachably couple to the user's hand.

The attachment member may further include a friction material to provide grip for the user's hand.

The first surface of the mobile device may be configured to capture an image and the second surface is configured to display a captured image.

The adjustable coupling member may further include a first hinge configured to allow the device mounting member to rotate about the first axis and a second hinge configured to allow the device mounting member to fold about the second axis.

The adjustable coupling member may further include a detachable coupling member configured to allow the device mounting member to detach from the adjustable coupling member.

The detachable coupling member may include a magnet. However, the present general inventive concept is not limited thereto. That is, the detachable coupling member may include various other conventionally known methods of allowing the device mounting member to be easily detached (and reattached) to the adjustable coupling member.

The adjustable coupling member may further include a locking mechanism configured to releasably hold the device mounting member in the first position and in the second position.

The adjustable coupling member may further include a locking mechanism configured to releasably hold the device mounting member in incremental orientations between the first orientation and the second orientation.

The device mounting member may further include a friction material to allow incremental position adjustments between the first position and second position and between the first orientation and the second orientation.

The friction material may releasably hold the device mounting member in a desired position and orientation.

### BRIEF DESCRIPTION OF THE FIGURES

These and/or other aspects of the present general inventive concept will become apparent and more readily appreciated from the following description of the various embodiments, taken in conjunction with the accompanying drawings of which:

FIG. 1 illustrates a back-perspective view of an adjustable mobile device mount according to one or more embodiments of the present general inventive concept;

FIG. 2 illustrates a back view of the adjustable mobile device mount illustrated in FIG. 1, coupled to a user;

FIG. 3 illustrates a front view of the adjustable mobile device mount illustrated in FIG. 2;

FIG. 4 illustrates a top view of the adjustable mobile device mount illustrated in FIG. 1;

FIG. 5 illustrates an enlarged cross-sectional view of the adjustable mobile device mount 100 along line A-A as shown in FIG. 4;

FIG. 6 illustrates an enlarged cross-sectional view of the adjustable mobile device mount 100 along line B-B as shown in FIG. 4;

FIG. 7A illustrates a back-perspective view of the adjustable mobile device mount illustrated in FIG. 1, wherein the device mounting member is rotated about 180 degrees and is in the first position (i.e., closed position);

FIG. 7B illustrates a back-perspective view of the adjustable mobile device mount illustrated in FIG. 7A, wherein the device mounting member is rotated about 135 degrees from the first position; and

FIG. 7C illustrates a back-perspective view of the adjustable mobile device mount illustrated in FIG. 7A, wherein the device mounting member is in the second position (i.e., open position) and the mobile device is rotated about 180 degrees.

### DETAILED DESCRIPTION OF PREFERRED EMBODIMENTS

Reference will now be made to example embodiments of the present general inventive concept, examples of which are illustrated in the accompanying drawings and illustrations. The example embodiments are described herein in order to explain the present general inventive concept by referring to the figures.

The present general inventive concept provides an adjustable mount for a variety of electronic devices including mobile devices, tablets, cameras, video recorders or the like, which may be adjusted between a plurality of positions and orientations, for ease of use and to reduce stress and fatigue of a user's wrist.

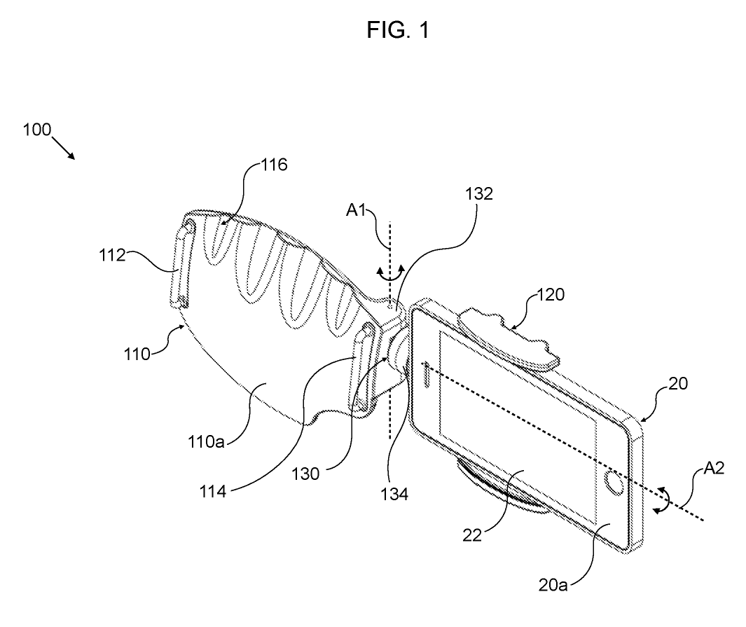

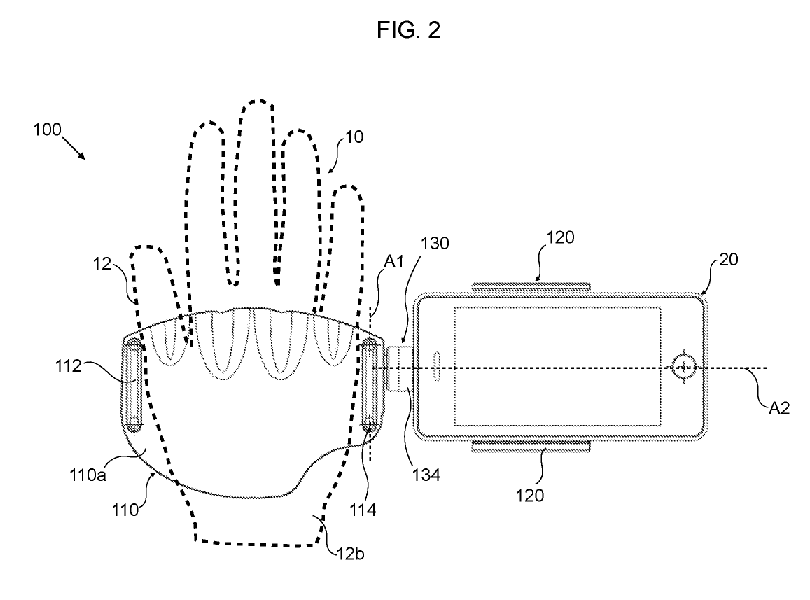

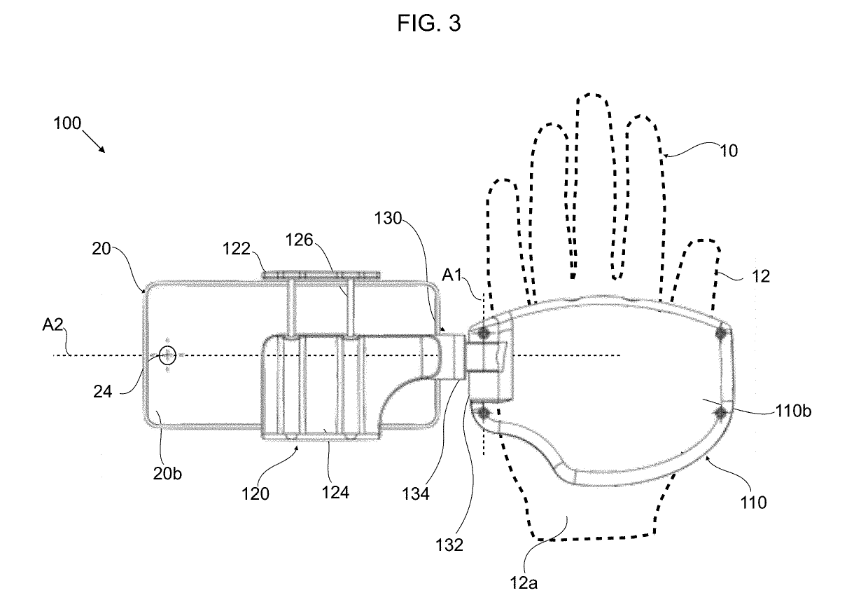

FIG. 1 illustrates a back-perspective view of an adjustable mobile device mount 100 according to one or more embodiments of the present general inventive concept, FIG. 2 illustrates a back view of the adjustable mobile device mount 100 illustrated in FIG. 1, coupled to a user 10, and FIG. 3 illustrates a front view of the adjustable mobile device mount 100 illustrated in FIG. 2.

Referring to FIGS. 1 to 3, in an exemplary embodiment, the adjustable mobile device mount 100 includes an attachment member 110 configured to detachably attach to a user's hand 12, a device mounting member 120 configured to detachably support a mobile device 20, and an adjustable coupling member 130 disposed and connected between the attachment member 110 and the device mounting member 120 and configured to allow the user 10 to quickly unfold the mobile device 20 from a stored position (i.e., a first position P1) to usable position (i.e., a second position P2).

In the present exemplary embodiment, the attachment member 110 includes a first side 110a and an opposing second side 110b. The attachment member 110 may be configured to detachably couple to various parts of a user 10, including the user's 10 wrist, hand, arm, leg, or the like, and the first side 110a may be configured to contact the user 10. However, the present general inventive concept is not limited thereto.

Referring to FIG. 3, in the present exemplary embodiment, the first side 110a of the attachment member 110 is configured to contact and couple to a palm side 12a of the user's hand 12. However, the present general inventive concept is not limited thereto.

In alternative exemplary embodiments, the attachment member 110 may further include an elastic strap coupled to the first side 110a of the attachment member 110 in order to detachably couple to the user's hand 12. In the present exemplary embodiment, the first side 110a of the attachment member 110 includes a first attachment rod 112 and a second attachment rod 114 to which an elastic strap may be affixed to secure the attachment member 110 to the user's hand 12.

In exemplary embodiments, the first side 110a of the attachment member 110 may further include recesses or contours 116 which correspond to or match a profile of a user's hand 12. In alternative embodiments, the attachment member 110 may further include a friction material (not illustrated) coupled to the first side 110a in order to provide grip for the user's hand 12.

In the present exemplary embodiment, the device mounting member 120 is configured to detachably support a mobile device 20 having a first surface 20a and an opposing second surface 20b. The first surface 20a may include a display screen 22 which may be used to display a captured image and/or video and the second surface 20b may include an image capturing device 24 (i.e., camera) which may be used to capture the image and/or video. The device mounting member 120 includes an adjustable member 122 slidably coupled to a base member 124 via rods 126. The user 10 may slidably adjust a distance between the adjustable member 122 and the base member 124 in order to accommodate and secure various types and sizes of mobile devices 20.

In the present exemplary embodiment, the second surface 20b of the mobile device 20 is configured to capture an image or video, and the second surface 20a is configured to display a captured image or video. However, the present general inventive concept is not limited thereto.

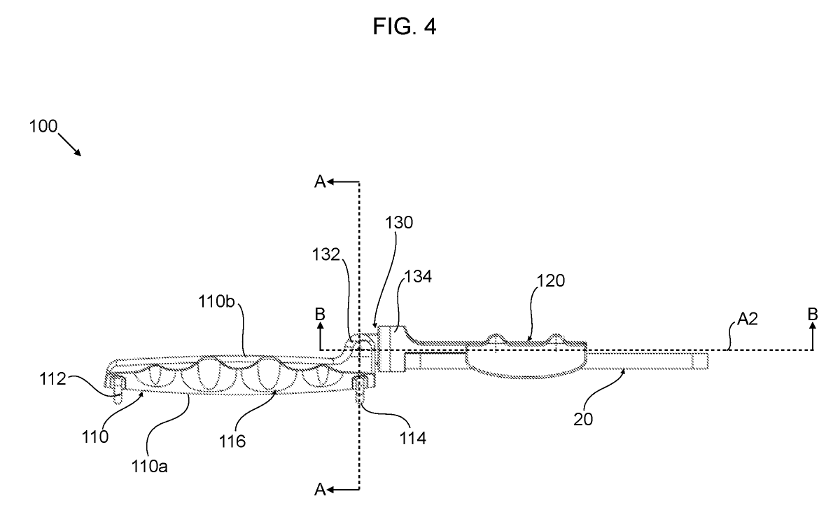

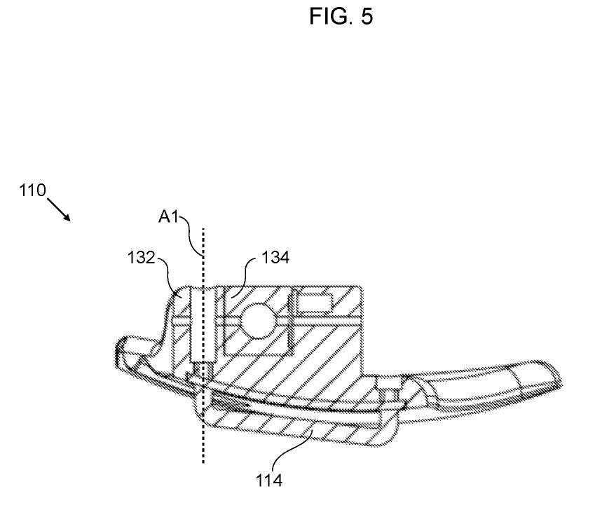

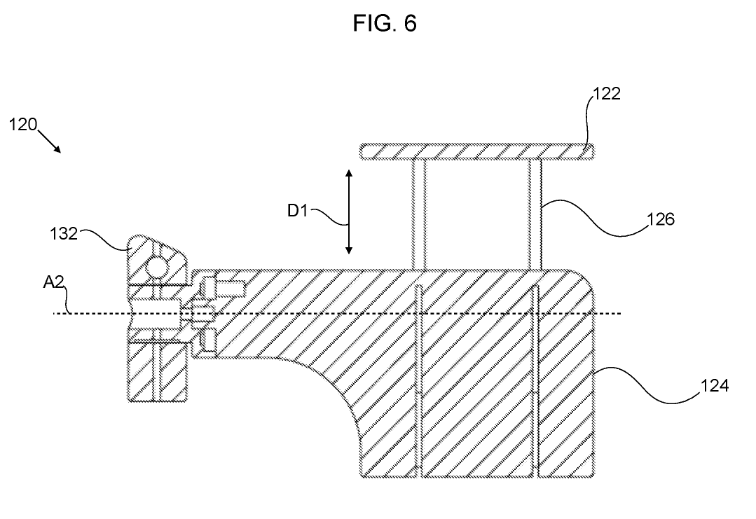

FIG. 4 illustrates a top view of the adjustable mobile device mount 100 illustrated in FIG. 1, FIG. 5 illustrates an enlarged cross-sectional view of the adjustable mobile device mount 100 along line A-A as shown in FIG. 4, and FIG. 6 illustrates an enlarged cross-sectional view of the adjustable mobile device mount 100 along line B-B as shown in FIG. 4.

Referring to FIG. 4 to 6, in the present exemplary embodiment, the adjustable coupling member 130 is disposed and coupled in between the attachment member 110 and the device mounting member 120. The adjustable coupling member 130 includes a first hinge member 132 which allows the device mounting member 120 to rotate the mobile device 20 around the first axis A1 between the first position P1 to the second position P2, and a second hinge member 134 which allows the device mounting member 120 to rotate around the second axis A2 between the first orientation and the second orientation. However, the present general inventive concept is not limited thereto.

In alternative exemplary embodiments, the first hinge member 132 allows the device mounting member 120 to fold between the first position P1 and the second position P2 and the second hinge member 134 allows the device mounting member 120 to rotate the mobile device 20 to a plurality of orientations around the second axis A2.

In exemplary embodiments, the adjustable coupling member 130 may be configured to allow the mobile device 20 to fold between the first position P1 which is used to safely store the mobile device 20 and the second position which is used to stably maintain the mobile device 20 in a desired position and orientation for use.

In alternative exemplary embodiments, the adjustable coupling member 130 may be configured to maintain and/or hold the device mounting member 120 in various incremental positions between the first position P1 and the second position P2, as desired by the user 10.

As such, the adjustable mobile device mount 100 according to the present general inventive concept allows a user 10 to quickly unfold the mobile device 20 from the storage position (i.e., the first position P1) to the usable position (i.e., the second position P2) and then adjust an orientation of the mobile device 20 to capture images and videos from the first surface 20a of the mobile device 20 and to reduce stress and fatigue experienced by the user's hand 12. However, the present general inventive concept is not limited thereto. That is, in alternative embodiments, the adjustable mobile device mount 100 is designed and/or configured to support a weight of the mobile device 20 or any other type of device coupled to the device mounting member 120 to allow the user 10 to easily maintain the device in a desired position and orientation for an extended period, without risking injury to the user's hand or wrist.

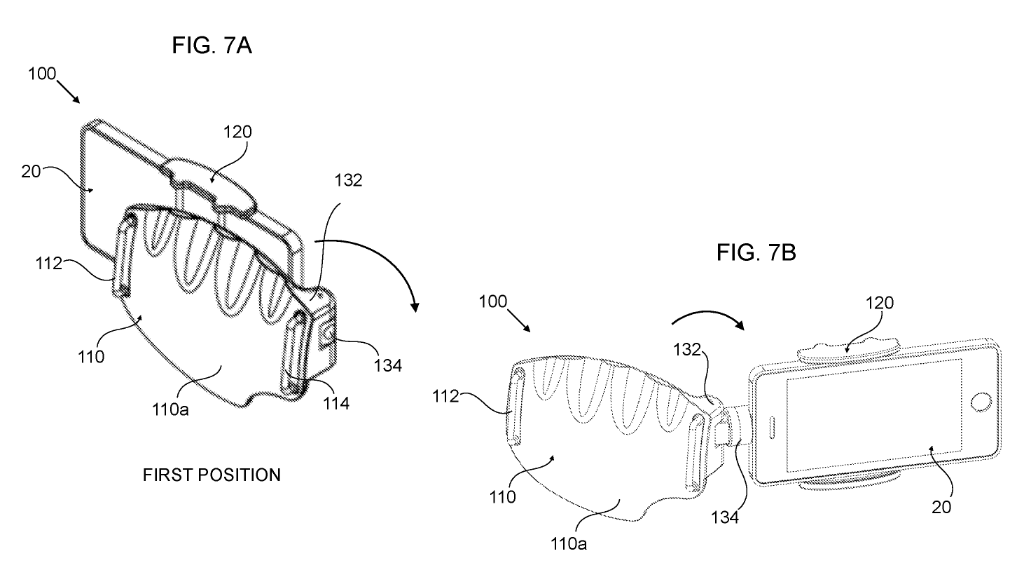

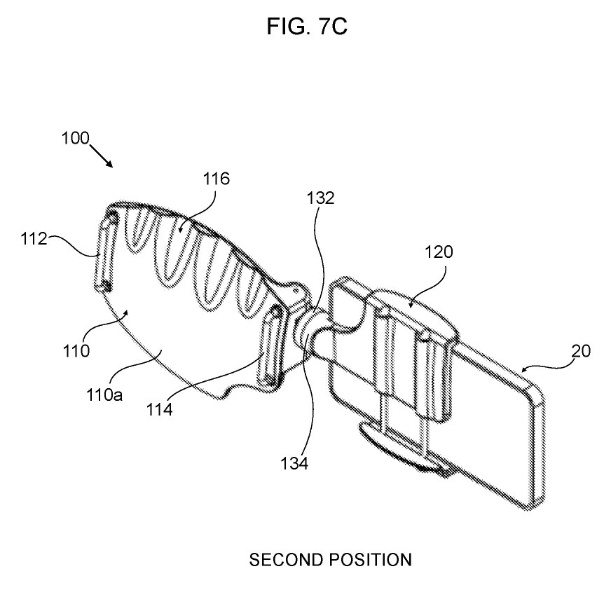

FIG. 7A illustrates a back-perspective view of the adjustable mobile device mount 100 illustrated in FIG. 1, wherein the device mounting member 120 is rotated about 180 degrees and is in the first position (i.e., closed position), FIG. 7B illustrates a back-perspective view of the adjustable mobile device mount 100 illustrated in FIG. 7A, wherein the device mounting member 120 is rotated about 135 degrees from the first position, and FIG. 7C illustrates a back-perspective view of the adjustable mobile device mount 100 illustrated in FIG. 7A, wherein the device mounting member 120 is in the second position (i.e., open position) and the mobile device is rotated about 180 degrees.

Referring to FIGS. 7A through 7C, the adjustable coupling member 130 is configured to unfold the mobile device 20 from the first position (i.e., the storage position P1) to the second position (i.e., the in-use position P2) about a first axis A1 and rotate between a plurality of orientations around a second axis A2. That is, in the present exemplary embodiment, the adjustable coupling member 130 is designed and/or configured to allow the mobile device 20 to rotate between the first position P1 and the second position P2 around the first axis A1 and rotate between a first orientation and a second orientation to allow the user 10 to precisely orient the mobile device 20 with respect to a desired object to film or capture a still image of.

In alternative exemplary embodiments, the adjustable coupling member 130 includes a first hinge member 132 which allows the device mounting member 120 to fold between the first position P1 and the second position P2 and a second hinge member 134 which allows the device mounting member 120 rotate around the second axis A2 between the first orientation and the second orientation.

In alternative exemplary embodiments, the adjustable coupling member 130 may include a detachable coupling member which is configured to allow the device mounting member 120 to detach from the adjustable coupling member 130. The detachable coupling member may include a magnet which allows the device mounting member 120 to be detachably coupled to the adjustable coupling member 130. However, the present general inventive concept is not limited thereto.

In exemplary embodiments, the first surface 20a of the mobile device 20 and the first side 110a of the attachment member 110 face a same first direction D1 in the first orientation and the first surface 20a of the mobile device 20 and the second side 110b of the attachment member 110 face a same second direction D2 in the second orientation. However, the present general inventive concept is not limited thereto.

In alternative exemplary embodiments, the adjustable coupling member 130 may further include a locking mechanism configured to releasably hold the device mounting member 120 in the first position and in the second position.

In yet further exemplary embodiments, the adjustable coupling member 130 may further include a locking mechanism configured to releasably hold the device mounting member 120 in incremental orientations between the first orientation and the second orientation.

In further exemplary embodiments, the device mounting member 120 may further include a friction material which allows a user to adjust the mobile device 20 between a plurality of positions between the first position and the second position, and also between a plurality of orientations between the first orientation and the second orientation.

In alternative exemplary embodiments, the adjustable coupling member 130 may further includes a self-stabilizing member (not illustrated) which helps stabilize the first surface 20a of the mobile device 20 with respect to a ground surface. The self-stabilizing member may maintain the first surface 20a of the mobile device 20 perpendicular with respect to the ground surface.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. An adjustable mobile device mount, comprising:
an attachment member having a first side and an opposing second side, the attachment member configured to detachably couple to a user;
a device mounting member configured to detachably support a mobile device having a first surface and an opposing second surface; and
an adjustable coupling member disposed between the attachment member and the device mounting member configured to rotate the mobile device along a first axis and a second axis orthogonal to the first axis.

2. The adjustable mobile device mount of claim 1, wherein the adjustable coupling member is configured to allow the mobile device to fold between a first position for use and a second position for storage.

3. The adjustable mobile device mount of claim 2, wherein the adjustable coupling member is further configured to allow the mobile device to rotate between a first orientation and a second orientation.

4. The adjustable mobile device mount of claim 3, wherein the first surface of the mobile device and the first side of the attachment member face a same first direction in the first orientation and the first surface of the mobile device and the second side of the attachment member face a same second direction in the second orientation.

5. The adjustable mobile device mount of claim 1, wherein the adjustable coupling member further includes a self-stabilizing member which stabilizes the first surface of the mobile device with respect to a ground surface.

6. The adjustable mobile device mount of claim 5, wherein the self-stabilizing member keeps the first surface of the mobile device perpendicular with respect to the ground surface.

7. The adjustable mobile device mount of claim 1, wherein the attachment member is configured to detachably couple to the user's hand.

8. The adjustable mobile device mount of claim 7, wherein the first side of the attachment member contacts the user's hand.

9. The adjustable mobile device mount of claim 8, wherein the attachment member further includes an elastic strap member to detachably couple to the user's hand.

10. The adjustable mobile device mount of claim 8, wherein the attachment member further includes a friction material to provide grip for the user's hand.

11. The adjustable mobile device mount of claim 8, wherein the first surface of the mobile device is configured to capture an image and the second surface is configured to display a captured image.

12. The adjustable mobile device mount of claim 1, wherein the adjustable coupling member includes a first hinge configured to allow the device mounting member to rotate about the first axis and a second hinge configured to allow the device mounting member to fold about the second axis.

13. The adjustable mobile device mount of claim 12, wherein the adjustable coupling member includes a detachable coupling member to allow the device mounting member to detach from the adjustable coupling member.

14. The adjustable mobile device mount of claim 13, wherein the detachable coupling member includes a magnet.

15. The adjustable mobile device mount of claim 2, wherein the adjustable coupling member further includes a locking mechanism configured to releasably hold the device mounting member in the first position and in the second position.

16. The adjustable mobile device mount of claim 3, wherein the adjustable coupling member further includes a locking mechanism configured to releasably hold the device mounting member in incremental orientations between the first orientation and the second orientation.

17. The adjustable mobile device mount of claim 3, wherein the device mounting member further includes a friction material to allow incremental position adjustments between the first position and second position and between the first orientation and the second orientation.

18. The adjustable mobile device mount of claim 17, wherein the friction material releasably holds the device mounting member in a desired position and orientation.
